(19) United States
(12) Patent Application Publication
(10) Pub. No.: US 2008/0014421 A1
(43) Pub. Date: Jan. 17, 2008

(54) Coated cutting tool with anodized top layer and method of making the same

(76) Inventors: Aharon Inspektor, Pittsburgh, PA (US); Mark S. Greenfield, Greensburg, PA (US); Kent P. Mizgalski, Stahlstown, PA (US); Joseph M. Tauber, Harrison City, PA (US)

Correspondence Address: KENNAMETAL INC., P.O. BOX 231, 1600 TECHNOLOGY WAY, LATROBE, PA, 15650, US

(21) Appl. No.: 11/486,228

(22) Filed: Jul. 13, 2006

(51) Int. Cl. B32B 7/02

(52) U.S. Cl. 428/216

(57) ABSTRACT

A coated cutting tool for chipforming machining of materials, as well as a method for making the same, wherein the coated cutting tool includes a substrate. The substrate has a rake surface and a flank surface wherein there is a cutting edge at the intersection of the rake surface and the flank surface. There is a coating scheme on at least a portion of one of the rake surface or the flank surface of the substrate. The coating scheme includes a top oxide interference film that visually appears to be colored when viewed under white lighting formed by full or partial anodization of an anodizable layer.

### BACKGROUND OF THE INVENTION

The invention pertains to a coated cutting tool, as well as a method of making a coated cutting tool. More specifically, the invention concerns a colored coated cutting tool and a method for making such a cutting tool.

Heretofore, product identification of articles via color coating has been available. In this regard, Guhring Coating Services of Brookfield, Wis. 53008-0643, a coating service company, provides coating services wherein cutting tools and wear parts can be coated so that the coatings exhibit different colors. In a brochure (1997) by Coloring Coating Services, coating layers of different materials are disclosed as exhibiting different colors. According to the Coloring Coating Services brochure, a TiN—S coating is deposited by physical vapor deposition (PVD) and has a gold color. The TiAlN-A-coat is deposited by physical vapor deposition and has a black violet color. A TiCN—C-coat is deposited by physical vapor deposition and has a gray violet color. The FIREX® F-coat is deposited by physical vapor deposition and presents a color that can be variable between a black color to a red violet color.

Further, CemeCon Inc. provides a so-called “Hay blue” coating based on the Supernitride TINALOX® SN coating material. This “Hay blue” coating has been used on, for example, starter ring gears.

Even though some cutting tools have been colored, it appears that these different colors are the result of using different coating compositions.

Heretofore, it has been known that titanium can be anodized to produce a surface that exhibits different colors. One exemplary internet website is that of Titanium Finishing Company of 248Main Street, East Greenville, Pa. 18041. The website of Titanium Finishing Company (i.e., www.titaniumfinishing.com) states that by varying the coating (oxides of titanium) a wide range of colors can be produced. Another exemplary internet website is from Electropolishing Systems, Inc., 24 Aldrin Road, Plymouth, Mass. 02360. The website of Electropolishing Systems (i.e., www.electropolishingsystems.com) discusses titanium anodizing by saying, among other things, that by precisely specifying the surface oxide level on the titanium component, an entire range of colors can be produced.

Even though titanium and titanium articles have been anodized to develop articles with any one of a number of different coatings, the anodization has been of solid articles of titanium or titanium alloy. For the most part, the titanium/titanium alloy articles that have been anodized have been jewelry or the like wherein the coloration has been for decorative purposes. In an application like bolts, the coloration has been used to indicate a specific size.

U.S. Pat. No. 3,989,876 to Mogi et al. discloses the anodization of structural articles made of titanium so as to improve the adhesion characteristics of the article. According to the Mogi et al. patent, an anodized titanium article has better adhesion properties with respect to adhesives, sealants, and organic coatings applied thereto. U.S. Pat. No. 5,160,599 to Kobayashi et al. also discloses that articles of titanium and titanium alloys can be anodized. The color of the surface of the article can vary depending upon the thickness of the film of titanium oxide, which is the result of the anodization process.

It is apparent that there is a need to provide a coated cutting tool that exhibits (or can exhibit) color coding. By color coding coated cutting tools, one has the potential to increase the brand identification. Further, such color coded articles can delineate different applications, sizes and/or geometries of cutting tools. Color coding of coated cutting tools can also facilitate better inventory control since it would be easier to quickly identify the nature of the cutting tool.

The physical vapor deposition of a thin film (which has a preferable thickness equal to 500-2000 A° thick) has been used to create different colored films. The color of these films are interference colors wherein only slight differences in the thickness of the film (or a slight difference in the combination of the layers in a multi-layer coating scheme) can result in different colors. Thus, it is very important when depositing a thin film via physical vapor deposition for the purpose of coloration, to have precise control over the process to achieve a uniform coating thickness.

As can be appreciated, to obtain precise process control increases the expense of the process. When precise process is necessary, there exists the challenge to consistently produce thin oxide films of precise thicknesses corresponding to preselected colors. This challenge becomes particularly significant when the coating process coats large batches of articles.

It would thus be desirable to provide a coated cutting tool and wear part, as well as a method to make the same, that has a thin oxide interference color film thereon that is of a consistent predetermined thickness.

### SUMMARY OF THE INVENTION

In one form thereof, the invention is a coated cutting tool for chipforming machining of materials. The cutting tool comprises a substrate that has a rake surface and a flank surface wherein there is a cutting edge at the intersection of the rake surface and the flank surface. There is a coating scheme on at least a portion of one of the rake surface or the flank surface of the substrate wherein the coating scheme includes a top oxide interference film that visually appears to be colored when viewed under white lighting.

In still another form thereof, the invention is a method for making a coated cutting tool for chipforming machining of material, the method comprising the steps of: providing a substrate having a rake surface and a flank surface wherein there is a cutting edge at the intersection of the rake surface and the flank surface; depositing a pre-anodization coating scheme on at least a portion of the rake surface or the flank surface wherein the pre-anodiation coating scheme includes a top anodizable layer; and anodizing the top anodizable layer so as to form a top oxide interference film that visually appears to be colored when viewed under white lighting.

### BRIEF DESCRIPTION OF THE DRAWINGS

The following is a brief description of the drawings that form a part of this patent application:

FIG. 1 is an isometric view of a solid end mill using a colored coated cutting tool of the present invention;

FIG. 2 is an isometric of a drill having a thin oxide interference color film formed thereon;

FIG. 3A is a schematic view of a specific embodiment of a hard insert of the invention illustrating in cross-section a substrate having a coating scheme that comprises an underlayer coating arrangement deposited on the substrate and the top anodizable coating layer deposited on the underlayer coating arrangement;

FIG. 3B is a schematic view of a specific embodiment of a hard insert of the invention illustrating in cross-section a substrate beginning with the coating scheme as illustrated in FIG. 3A, but where the top anodizable coating layer of FIG. 3A has been fully anodized to form the top colored coating layer;

FIG. 3C is a schematic view of a specific embodiment of a hard insert of the invention illustrating in cross-section a substrate beginning with the coating scheme as illustrated in FIG. 3A, but where the top anodizable coating layer of FIG. 3A has been partially anodized to form the top colored coating layer and wherein a portion of the top anodizable coating layer still remains;

FIG. 4 is a schematic view of a specific embodiment of a hard insert of the invention illustrating in cross-section a substrate having a coating scheme that comprises an underlayer coating arrangement deposited on the substrate and an electrically insulating coating layer scheme deposited on the underlayer coating arrangement and a top colored coating layer on the electrically insulating coating layer scheme wherein the top anodizable coating layer has been fully anodized to form the top colored coating layer;

FIG. 4A is a schematic view of a specific embodiment of a hard insert of the invention illustrating in cross-section a substrate having a coating scheme that comprises an underlayer coating arrangement deposited on the substrate and an electrically insulating coating layer scheme deposited on the underlayer coating arrangement and an anodizable coating layer-top coating layer arrangement on the electrically insulating coating layer scheme wherein the anodizable coating layer has been partially anodized to form the top colored coating layer and wherein a portion of the initial top anodizable coating layer still remains;

FIG. 5 is a schematic view of a specific embodiment of a hard insert of the invention illustrating in cross-section a substrate having a coating scheme that comprises an underlayer coating arrangement deposited on the substrate and a top colored coating layer on the underlayer coating arrangement and wherein the top anodizable coating layer has been fully anodized to form the top coating layer;

FIG. 5A is a schematic view of a specific embodiment of a hard insert of the invention illustrating in cross-section a substrate having a coating scheme that comprises an underlayer coating arrangement deposited on the substrate and an anodizable coating layer-top colored coating layer arrangement on the underlayer coating scheme and wherein the anodizable coating layer has been partially anodized to form the top colored coating layer and wherein a portion of the initial anodizable coating layer still remains; and

FIG. 6 is a photograph of coated cutting tools comprising Inventive Examples 1 through 7.

### DETAILED DESCRIPTION OF THE INVENTION

The present invention is a colored coated cutting tool (such as, for example and without limitation, a ball mill, a drill and a cutting insert), as well as a method for making the colored coated cutting tool. The cutting tool exhibits color corresponding to the nature of the coating scheme as will be discussed in more detail hereinafter. By utilizing color, one can increase brand identification, as well as delineate between different applications for and sizes of and geometries of the cutting tool. The use of color also facilitates better inventory control since it is easier to more quickly identify the nature and properties of the cutting tools that remain in inventory.

Further, the use of a coating scheme that colorizes a cutting tool has another advantage in that the operator can ascertain when the cutting tool has progressed to a point at or near the end of its useful life. In this regard, as the cutting tool wears, the coating scheme also wears so that the visually perceivable color changes in response to the extent of the use (or degree of wear) of the cutting tool. When the cutting tool reaches the end of its useful life, the color of the used cutting edge can be different from that of a new cutting tool thereby indicating to the operator that the cutting tool has reached the end of its useful life. The operator can then remove the cutting tool before it goes past its useful life. This is advantageous because chipforming machining of a workpiece using a cutting tool that has worn past its useful life may not produce satisfactory results.

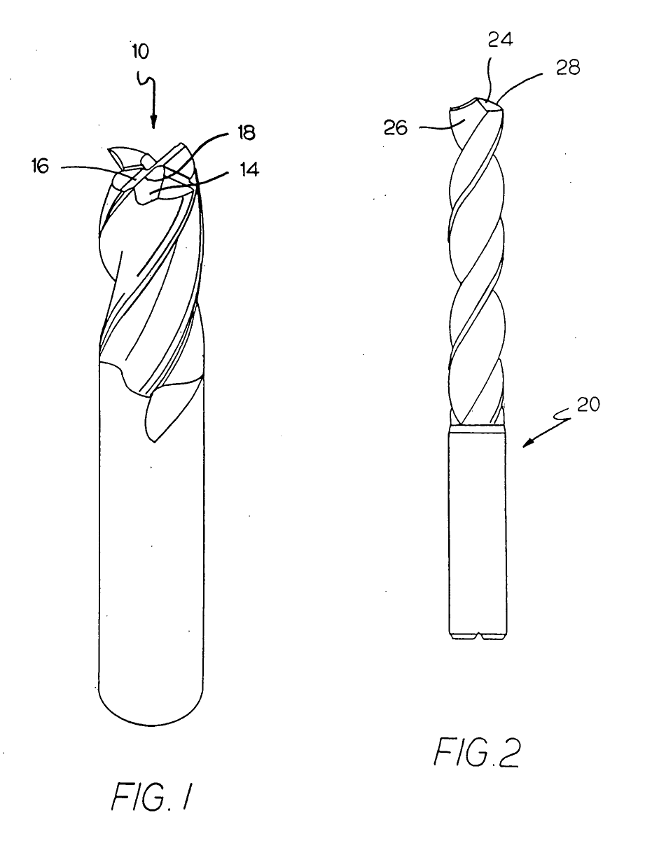

FIG. 1 illustrates a solid end mill 10 that is a colored cutting tool of the present invention. The solid end mill 10 is shown and described in U.S. Pat. No. 6,742,968 to Volokh for a MILLING CUTTER and assigned to Kennametal Inc. of Latrobe, Pa. 15650., which is hereby incorporated by reference herein. Referring to FIG. 1, the solid end mill 10 has a rake face 16 and a flank face 14 wherein there is a cutting edge 18 at the intersection thereof. The solid end mill (i.e., cutting tool) 10 is useful in the chipforming machining of materials (e.g., a workpiece).

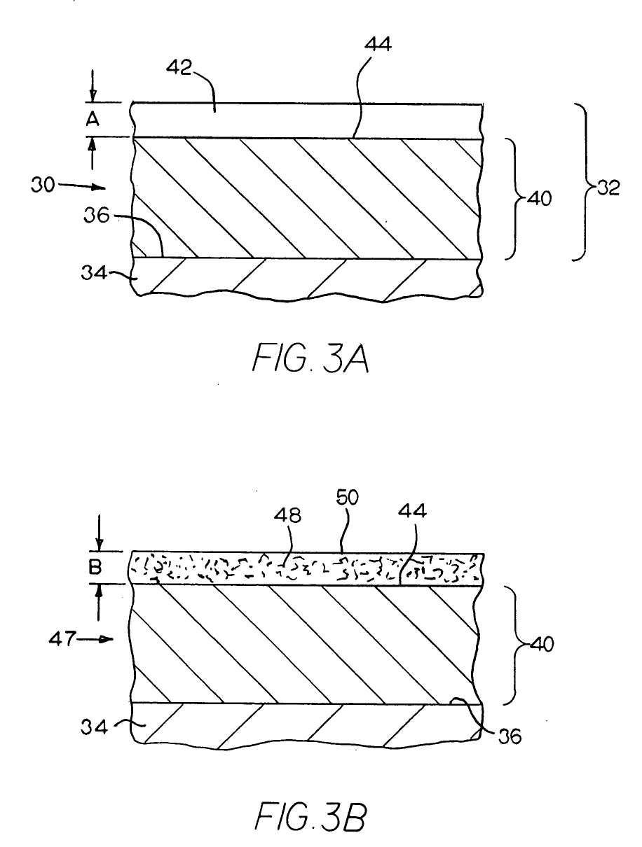

FIG. 2 illustrates a drill 20. Drill 20 is coated so as to exhibit a pre-selected color. The drill 20 is shown and described in U.S. Pat. No. 6,688,817 to Borschert et al., which is hereby incorporated by reference herein. The drill 20 has a rake face 24 and a flank face 26 wherein there is a cutting edge 28 at the intersection thereof. Drill 20 can be considered to be a cutting tool for chipforming machining of materials.

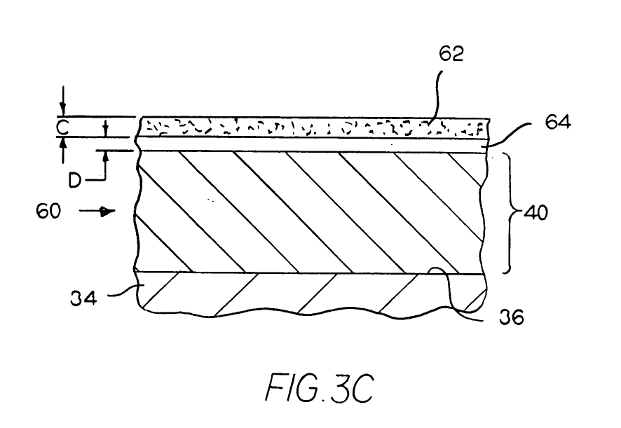

Referring to the specific embodiment illustrated in FIGS. 3A, 3B and 3C, FIG. 3A shows a pre-anodized cutting tool (generally designated as 30) with a pre-anodizable coating scheme (bracket 32) thereon. In this regard, the pre-anodized cutting tool 30 comprises a substrate 34 that has at least one surface 36. While the substrate 34 may vary in composition depending upon the application, the material for the substrate can be selected from the group comprising cemented carbides (e.g., cobalt cemented tungsten carbides), ceramics (e.g., SiAlON's) and cermets (titanium carbonitride-based materials) and high speed steels).

The pre-anodizable coating scheme 32 includes an underlayer coating arrangement shown by brackets 40. The underlayer coating arrangement 40 may take on any one of many different coating architectures. It may comprise a single coating layer or it may comprise a plurality of coating layers possibly in a periodic sequence or not in a periodic sequence. The thicknesses of the various coating layer(s) in the underlayer coating arrangement 40 can also vary depending upon the specific application.

The method to apply the coating underlayer arrangement 40 may also vary depending upon the application wherein the method may include physical vapor deposition, chemical vapor deposition, and various variations or modifications or combinations thereof known to those of ordinary skill in the art. Exemplary coating arrangements that could serve as the underlayer coating arrangement 40 are shown and described in the following U.S. Pat. No. 5,864,297 and U.S. Pat. No. 5,858,181 to Jindal et al. for Physical Vapor Deposition of Titanium Nitride on a Nonconductive Substrate, U.S. Pat. No. 5,879,823 to Prizzi et al. for a Coated Cutting Tool, and U.S. Pat. No. 5,364,209 to Santhanam et al. for a Coated Cutting Tools. Each one of these patents is assigned to Kennametal Inc. of Latrobe, Pa. 15650 United States of America, and is hereby incorporated by reference herein.

The pre-anodizable coating scheme further includes a top anodizable layer 42. The top anodizable layer 42 is deposited on the outer surface 44 of the underlayer coating arrangement 40. The top anodizable layer 42 most preferably, comprises titanium metal. However, in addition to titanium metal, applicant contemplates that the top anodizable layer may comprise an alloy containing titanium and aluminum. Applicant also contemplates that the top anodizable coating layer 42 can be comprised of aluminum metal, zirconium, or chromium, as well as any combination thereof. One preferred method to apply the top anodizable layer 42 is physical vapor deposition. As illustrated in FIG. 3A, the thickness of the top anodizable layer 42 is “A”.

FIG. 3B illustrates a specific embodiment of a cutting tool generally designated as 47. Cutting tool 47 is the resultant cutting tool of completely (or fully) anodizing the top anodizable layer 42 of the pre-anodized cutting tool 30 (of FIG. 3A). The anodization typically occurs via electrochemical anodization or thermal anodization (also known as thermal oxidization) wherein the atmosphere can be oxygen. U.S. Published Pat. Application No. 2004/0131943 A1 to Brown et al. is exemplary of electrochemical anodization techniques, as well as thermal anodization techniques.

Upon the top anodizable layer 42 being fully (or completely) anodized, it forms the top colored coating layer 48, which has a top surface 50. The thickness of the top colored coating layer 48 is thickness “B” as illustrated in FIG. 3B.

Typically, the top colored coating layer 48 is an oxide wherein this oxide is the reaction product of the full (or complete) anodization of the anodizable layer 42. The voltage of the anodization process has a significant impact upon the thickness of the top layer. The top colored coating layer 48 is an interference color type of film (e.g., oxide interference film that visually appears to be colored when viewed under white lighting) so that the thickness of the top colored coating layer 48 determines the specific color exhibited by the film. In the case when the top colored coating layer 48 is titanium oxide, the color of the layer is dependent upon its thickness and it can comprise (without limitation) any one of the primary colors and any mixture thereof. Other colors could also be available depending upon possible variations (or additions) in the composition of the titanium oxide.

FIG. 3C illustrates a cutting tool generally designated as 60. Cutting tool 60 is the resultant cutting tool of partially anodizing the top anodizable layer 42 of the pre-anodized cutting tool 30 (of FIG. 3A). Like for the earlier embodiment, the anodization typically occurs via electrochemical anodization or thermal anodization wherein the atmosphere can be oxygen. In the case of partial anodization, the top colored coating layer 62 is an oxide (i.e., an oxide interference film that visually appears to be colored when viewed under white lighting) that is the reaction product of the partial anodization of the top anodizable layer 42; however, because there is only partial anodization, the cutting tool of FIG. 3C has an unreacted anodizable coating layer 64 that still remains.

As shown in FIG. 3C, the top colored coating layer 62 has a thickness “C” and the unreacted anodizable coating layer 64 has a thickness “D”. A comparison between the cutting tool from the full anodization (see FIG. 3B) and the cutting tool from the partial anodization (see FIG. 3C) shows that the thickness of the anodized top coating layer 48 of the fully anodized cutting tool 47 is greater than the thickness of the anodized top coating layer 62 of the partially anodized cutting tool 60. Since these coating layers (48, 62) are interference color films, the color of each coating layer will be different since each thickness is different.

It should be appreciated that cutting tools exhibiting different colors can be made from the same pre-anodizable cutting tool. The difference in colorization can be controlled by the degree of anodization of the anodizable top coating layer 42.

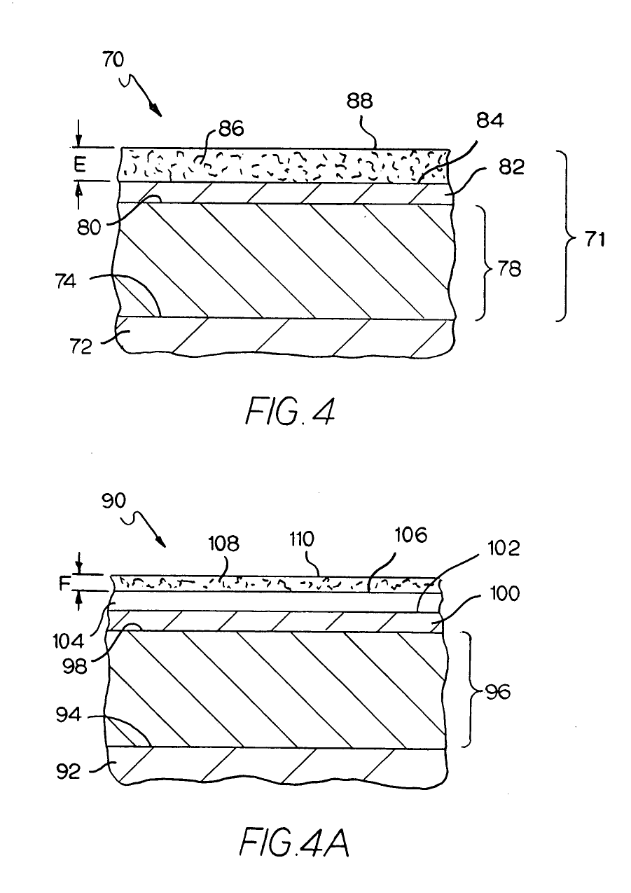

FIG. 4 illustrates a cutting tool generally designated as 70 that has thereon a second specific embodiment of a coating scheme (see bracket 71) after anodization. The cutting tool 70 includes a substrate 72 that has a top surface 74. In reference to the nature of the substrate 72, it could be made of any one of the materials described above suitable for the use as the substrate 34.

The overall coating scheme 71 includes an underlayer coating arrangement designated by bracket 78 that is deposited on the surface 74 of the substrate 72. The nature of the underlayer coating arrangement 78, as well as the method to apply the coating scheme, can be the same as the underlayer coating arrangement 40 described hereinabove.

The underlayer coating arrangement 78 has a top surface 80. An electrically insulating coating layer scheme 82 is deposited to the top surface 80 of the underlayer coating arrangement 78. The electrically insulating coating scheme 82 has a top surface 84. While the insulating coating layer scheme 82 generally comprises fewer layers than the underlayer coating arrangement, this may not always be the case. One exemplary electrically insulating coating is alumina (i.e., aluminum oxide).

The insulating coating layer scheme 82 may take on any one of many different coating architectures. It may comprise a single coating layer or it may comprise a plurality of coating layers possibly in a periodic sequence or not. The thicknesses of the various coating layer(s) in the insulating coating layer scheme can also vary depending upon the specific application. The method to apply the coating may also vary depending upon the application wherein the method may include physical vapor deposition, chemical vapor deposition, and various variations or modifications or combinations thereof known to those of ordinary skill in the art. Another preferred insulating coating layer scheme comprises a layer of titanium carbonitride deposited on the surface of the underlayer coating arrangement and with a layer of alumina deposited on the surface of the layer titanium carbonitride. Another preferred insulating coating layer scheme comprises a layer of aluminum titanium nitride that contains aluminum and titanium and wherein the aluminum content is greater than the titanium content.

A top colored coating layer 86 is on the surface 84 of the insulating coating layer scheme 82. Top colored coating layer 86 has a top surface 88. Top colored coating layer 86 is the result of the full or complete anodization of the top anodizable coating layer, which is like either top colored coating layer 48 of FIG. 3A or top colored coating layer 62 of FIG. 3C. The top colored coating layer 48 has a thickness “E”.

Typically, the top colored coating layer 86 is an oxide wherein this oxide is the reaction product of the full (or complete) anodization of the anodizable layer. The voltage of the anodization process has a significant impact upon the thickness of the top layer. The top colored coating layer 86 is an interference color type of film (e.g., an oxide interference film that visually appears to be colored when viewed under white lighting) so that the thickness of the top colored coating layer 86 determines the specific color exhibited by the film. In the case where the top colored coating layer 86 is titanium oxide, the color of the layer is dependent upon its thickness and it can comprise (without limitation) any one of the primary colors and any combination thereof. Other colors could also be available depending upon possible variations (or additions) in the composition of the titanium oxide.

It should be appreciated that a cutting tool along the lines of the cutting tool 70 of FIG. 4 can be made where the anodizable coating layer is only partially anodized. In this regard, the cutting tool 90 shown in FIG. 4A is this kind of cutting tool.

As shown in FIG. 4A, cutting tool 90 has a substrate 92 with a top surface 94. An underlayer coating arrangement (bracket 96), which has a top surface 98, is on the top surface 94 of the substrate 92. An electrically insulating layer 100, which has a top surface 102, is on the underlayer coating arrangement. An anodizable layer 104 is on the top surface 102 of the insulating layer 100. The anodizable layer 104 has a top surface 106. A top colored coating layer 108 is on the surface 106 of the anodizable layer 104. Top colored coating layer 108 has a top surface 110 and a thickness “F”. In the case of partial anodization, the top colored coating layer 108 is an oxide (i.e., an oxide interference film that visually appears to be colored when viewed under white lighting) that is the reaction product of the partial anodization of the anodizable layer; however, because there is only partial anodization, the cutting tool of FIG. 4A still has an unreacted anodizable coating layer 104.

As discussed above in conjunction with the cutting tools illustrated in FIG. 3B and 3C, FIG. 4 illustrates cutting tool 70, which is the resultant cutting tool of completely anodizing the top anodizable layer of the pre-anodized cutting tool and FIG. 4A illustrates cutting tool 90, which is the result of partially anodizing the top anodizable layer of the pre-anodized cutting tool. The anodization typically occurs via electrochemical anodization or thermal anodization wherein the atmosphere can be oxygen. U.S. Published Pat. Application No. 2004/0131943 A1 to Brown et al. is exemplary of electrochemical anodization techniques, as well as thermal anodization techniques.

A comparison between the cutting tool from the full anodization (see FIG. 4) and the cutting tool from the partial anodization (see FIG. 4A) shows that the thickness E of the anodized top coating layer 86 of the fully anodized cutting tool 70 is greater than the thickness F of the anodized top coating layer 108 of the partially anodized cutting tool 90. Since these coating layers are interference color films, the color of each coating layer will be different since each thickness is different.

It should be appreciated that cutting tools exhibiting different colors can be made from the same pre-anodizable cutting tool. The difference in colorization can be controlled by the degree of anodization of the anodizable top coating layer.

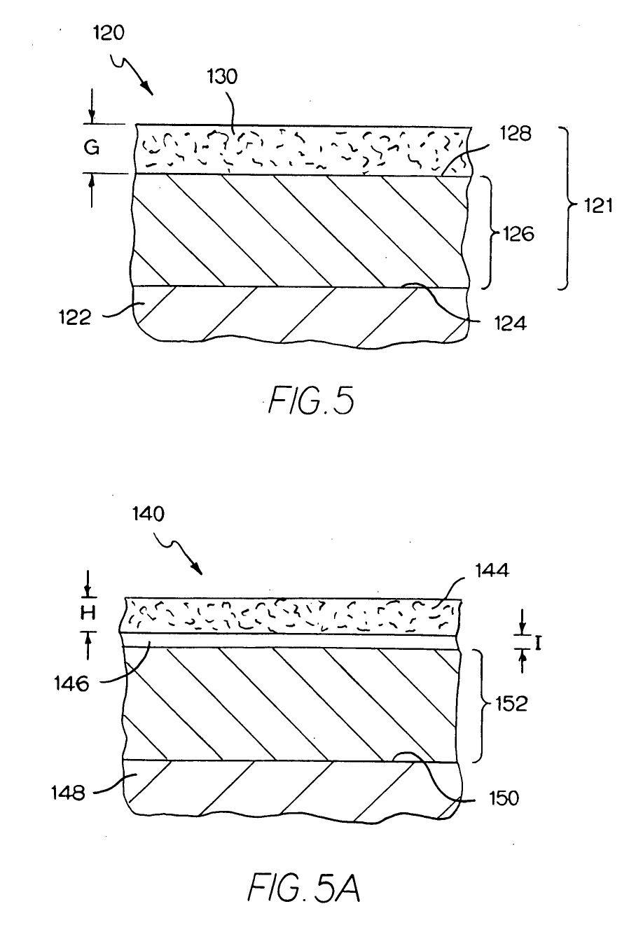

FIG. 5 illustrates a cutting tool generally designated as 120 that has thereon a second specific embodiment of a coating scheme after anodization. The cutting tool 120 includes a substrate 122 that has a top surface 124. The substrate 122 may be made from any of the materials suitable for use as the substrate 22 as described above.

The overall coating scheme (bracket 121) includes an underlayer coating arrangement designated by bracket 126 that is deposited on the surface 124 of the substrate 122. The underlayer coating arrangement 126 has a top surface 128. The nature of the underlayer coating arrangement 126, as well as the method to apply the coating arrangement, can be the same as the underlayer coating arrangement 40 described above in conjunction with the embodimentof FIGS. 3A through 3C. The underlayer coating arrangement 126 has a top surface 128.

An anodized top colored coating layer 130 is on the top surface 128 of the underlayer coating arrangement 126. Top colored coating layer 130 has a thickness “G”. As described above in connection with top colored coating layer 48, the preferred material for this layer 130 is titanium oxide (i.e., an oxide interference film that visually appears to be colored when viewed under white lighting). The color that layer 130 exhibits may be dependent upon the thickness of layer 130. It should be appreciated that while layer 130 is fully anodized, the anodizable coating layer may be only partially anodized as will be shown in FIG. 5A.

FIG. 5A shows a cutting tool generally designated as 140 in which the anodizable layer is only partially anodized. In this regard, the top colored coating layer 144 (e.g., an oxide interference film that visually appears to be colored when viewed under white lighting) has a thickness “H” and the unreacted anodizable coating layer 146 has a thickness “I”. Cutting tool 140 has a substrate 148 along the lines of substrate 22, and wherein substrate 148 has a top surface 150. Cutting tool 140 also has an underlayer coating arrangement 152 along the lines of arrangement 126.

A comparison between the cutting tool 120 from the full anodization (see FIG. 5) and the cutting tool 140 from the partial anodization (see FIG. 5A) shows that the thickness G of the anodized top coating layer 130 of the fully anodized cutting tool 120 is greater than the thickness H of the anodized top coating layer 144 of the partially anodized cutting tool 140. Since these coating layers are interference color films, the color of each coating layer will be different since each thickness is different. It should be appreciated that cutting tools exhibiting different colors can be made from the same pre-anodizable cutting tool. The difference in colorization can be controlled by the degree of anodization of the anodizable top coating layer.

It should be appreciated that the anodization process can either be a separate step or a part of a continuous process. When it is a separate step, the top anodizable coating layer is deposited and not followed immediately by the anodization step. When it is a part of a continuous process, the anodization step immediately follows the deposition of the top anodizable coating layer.

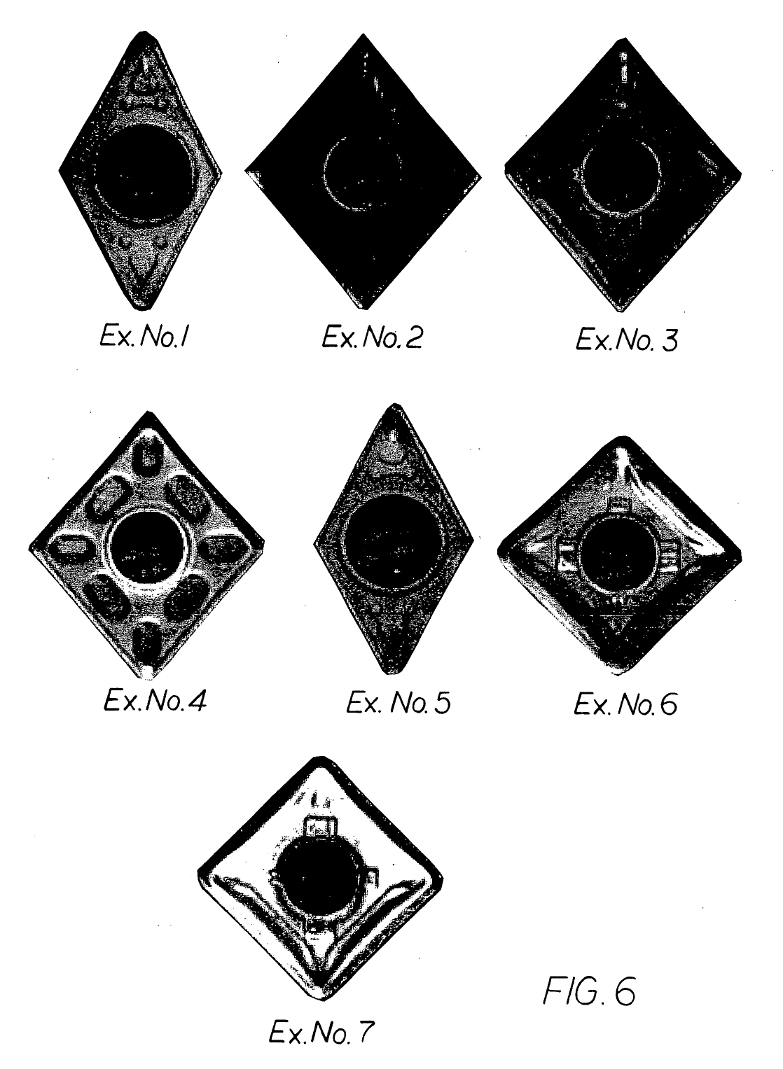

In reference to specific examples, the Inventive Examples Nos. 1 through 7 of cutting tools (as shown in FIG. 6) comprised different geometries wherein these geometries are known to those of ordinary skill in the art. For each one of the inventive example cutting tools, the substrate was cobalt cemented tungsten carbide. In the case of Inventive Examples Nos. 1 and 5, a layer of alumina (i.e., aluminum oxide) was applied via chemical vapor deposition (CVD) to the surface of the substrate and a layer of titanium was applied via physical vapor deposition (PVD) to the surface of the alumina layer. In the case of Inventive Examples Nos. 2, 3, 4, 6 and 7, a layer of titanium nitride was applied via PVD to the surface of the substrate and a layer of titanium was applied via PVD to the surface of the titanium nitride layer. For all of the inventive examples, the layer of titanium was applied to a thickness about equal to 0.5 micron.

For the anodization process for each one of the inventive cutting tools, the titanium layer was anodized per the anodization parameters set forth in Table 1 below. During the anodization process, the current was allowed to float. The anodized cutting tools were dipped in deionized water to remove the majority of the phosphoric acid, and then rinsed with flowing deionized water. The remaining water was blown off using compressed air.

As mentioned above, Table 1 below sets forth the anodization parameters (i.e., voltage in volts d.c. and duration in seconds) for Inventive Examples Nos. 1 through 7.

TABLE 1
Anodization Parameters (Voltage and Duration) for
Cutting Tool Inventive Examples Nos. 1 through 7

| Example No. | Voltage (volts d.c.) | Duration (seconds) |
|---|---|---|
| 1 | 10 | 20 |
| 2 | 20 | 20 |
| 3 | 30 | 20 |
| 4 | 30 | 60 |
| 5 | 41 | 10 |
| 6 | 40 | 20 |
| 7 | 40 | 60 |

FIG. 6 is a photograph that shows the cutting tools that comprise Inventive Examples Nos. 1 through 7 where each example is designated with its corresponding Example No. As can be seen from a review of the cutting tools shown in FIG. 6, the color of the cutting tool can vary depending upon the anodization parameters.

It is apparent that the present invention provides a colored coated cutting tool. By providing a colored coating cutting tool, one has the potential to increase the brand identification. Further, by providing a colored cutting tool, one can delineate different applications, sizes and/or geometries of cutting tools and/or wear parts. Colored coated cutting tools can also facilitate better inventory control since it would be easier to quickly identify the nature of the article. Also, by using a colored coated cutting tool, one can ascertain when the useful life of the cutting tool has been reached or will soon be reached. be

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. A coated cutting tool for chipforming machining of materials wherein the cutting tool comprising:
a substrate having a rake surface and a flank surface wherein there is a cutting edge at the intersection of the rake surface and the flank surface; and
a coating scheme on at least a portion of one of the rake surface or the flank surface of the substrate wherein the coating scheme including a top oxide interference film that visually appears to be colored when viewed under white lighting.

2. The coated cutting tool according to claim 1 wherein the top oxide interference film is formed by partial anodization of an anodizable layer.

3. The coated cutting tool according to claim 1 wherein the top oxide interference film is formed by full anodization of an anodizable layer.

4. The coated cutting tool according to claim 1 wherein the substrate is selected from the group comprising cemented carbides, ceramics, cermets, and high speed steels.

5. The coated cutting tool according to claim 1 wherein the anodizable layer comprises any one or more of the following: titanium, aluminum, zirconium, and chromium.

6. The coated cutting tool according to claim 1 wherein the coating scheme including an underlayer coating arrangement deposited on the surface of the substrate.

7. The coated article according to claim 6 wherein the underlayer coating arrangement is deposited on the substrate by physical vapor deposition or chemical vapor deposition or a combination of physical vapor deposition and chemical vapor deposition.

8. The coated cutting tool according to claim 6 wherein the coating scheme further including an insulating coating layer scheme deposited on the underlayer coating arrangement.

9. The coated cutting tool according to claim 8 wherein the insulating coating layer scheme comprising a layer of aluminum titanium nitride containing aluminum and titanium and wherein the aluminum content is greater than the titanium content.

10. The coated cutting tool according to claim 9 wherein the insulating coating layer scheme comprising a layer of titanium carbonitride and a layer of alumina on the layer of titanium carbonitride.

11. The coated cutting tool according to claim 9 wherein the insulating coating layer scheme comprising a layer of alumina.

12. The coated cutting tool according to claim 1 wherein the anodization is either electrolytic anodization or thermal anodization.

13. A method for making a coated cutting tool for chipforming machining of material, the method comprising the steps of:
providing a substrate having a rake surface and a flank surface wherein there is a cutting edge at the intersection of the rake surface and the flank surface;
depositing a pre-anodization coating scheme on at least a potion of the rake surface or the flank surface wherein the pre-anodization coating scheme including a top anodizable layer; and
anodizing the top anodizable layer so as to form a top oxide interference film that visually appears to be colored when viewed under white lighting.

14. The method of claim 13 wherein the anodizing step comprises fully anodizing the top anodizable layer.

15. The method of claim 13 wherein the anodizing step comprises partially anodizing the top anodizable layer.

16. The method of claim 13 wherein the depositing step and the anodizing step comprise a continuous process.

17. The method of claim 13 wherein the anodizing step is a separate step from the depositing step.

18. The method of claim 13 wherein the step of depositing a pre-anodization coating scheme comprises the steps of:
depositing an underlayer coating arrangement on the surface of the substrate; and
depositing the top anodizable layer on the underlayer coating arrangement.

19. The method of claim 13 wherein the step of depositing a pre-anodization coating scheme comprises the steps of:
depositing an underlayer coating arrangement on the surface of the substrate; and
depositing an insulating coating layer on the underlayer coating arrangement; and
depositing the top anodizable layer on the insulating coating layer.

20. The method of claim 13 wherein the depositing step comprises physical vapor deposition of the top anodizable layer.

21. The method of claim 13 wherein the anodizing step comprises electrolytic anodization.

22. The method of claim 13 wherein the anodizing step comprises thermal anodization.
